(19) United States
(12) Patent Application Publication
(10) Pub. No.: US 2009/0316413 A1
(43) Pub. Date: Dec. 24, 2009

(54) HEAT CONVECTION ELECTROMAGNETIC DISCHARGE LAMP

(75) Inventor: Michael Henry, Palo Alto, CA (US)

Correspondence Address: FERNANDEZ & ASSOCIATES LLP, 1047 EL CAMINO REAL, SUITE 201, MENLO PARK, CA, 94025, US

(73) Assignee: Raytech International Corporation, Palo Alto, CA (US)

(21) Appl. No.: 12/144,501

(22) Filed: Jun. 23, 2008

(51) Int. Cl. F21V 29/02

(52) U.S. Cl. 362/294

(57) ABSTRACT

An electromagnetic discharge lamp system having a high frequency generator, a power coupler, a lamp with a heat convection channel (HCC) extending through the length of the lamp, and a lamp cap. A meshed metal cover is disposed at the tip of the lamp. The lamp cap has holes through which the ambient air is drawn into the lamp cap. The air drawn into the lamp cap flows through the channel, extracting heat energy generated by the power coupler, and exits through the meshed metal cover. The electromagnetic discharge lamp also includes a standard lamp mount for easy installation as well as reduction in maintenance cost.

### CROSS REFERENCE TO RELATED APPLICATIONS

This application claims the benefit of Chinese Patent Application No. 200820114449.0, entitled “Heat Convection Electromagnetic Discharge Lamp,” filed on May 19, 2008, which is incorporated herein in its entirety.

### FIELD OF INVENTION

The present invention relates to an electromagnetic discharge lamp system, more particularly, to an electromagnetic discharge lamp system having a convection cooling mechanism.

### BACKGROUND OF INVENTION

An electromagnetic discharge lamp is a light source that uses electromagnetic field induction and gas discharge principles. Typically, it includes a high frequency generator, a power coupler, and a lamp. The high frequency generator generates a high frequency current in the range of 250 KHz through 2.65 MHz that flows through the induction coil on the power coupler and generates an electromagnetic field. The electromagnetic field incurs an electrical field that triggers a gas discharge of UV light. The UV light is converted into visible light by a fluorescent phosphor mixture coated on the inside of the wall of the lamp.

The discharge lamp has many advantages over traditional lamps and is considered a new light source that will dominate the market in the 21^{st} century. The discharge lamp has many unique features, but its power coupler generates a lot of heat during operation and this has been a technical bottleneck that hinders the commercialization of the lamp.

Discharge lamps so far all use a similar system to deal with the heat generated by the power coupler, in which a copper rod, used as a heat induction material, has one end attached to the power coupler and the other end attached to a relatively large piece of metal sheet which functions as a heat dissipating device and is fixed to lamp fixtures. This heat dissipating system, though works relatively well on low voltage discharge lamps, is not viable for high voltage discharge lamps that normally generate much more heat. Also, because this system uses a piece of metal to dissipate heat, it cannot have standard lamp mounts, causing inconvenience in installation and maintenance. Also partially because of the heat problem, a current discharge lamp does not have an integrated high frequency generator.

### SUMMARY OF INVENTION

According to one aspect of the present invention, an electromagnetic discharge lamp system includes a lamp operative to generate light by use of an electromagnetic field and having a channel extending there through, the channel being configured to communicate with ambient air and allow the ambient air to flow there through. The ambient air flowing through the channel extracts heat energy from the lamp system during operation.

### BRIEF DESCRIPTION OF DRAWINGS

FIG. 1 is a partial cut away side view of a heat convection channel (HCC) lamp having a pear-shape in accordance with one embodiment of the present invention.

FIG. 2 is a partial cut away side view of a heat convection channel (HCC) lamp having a bullet-shape in accordance with another embodiment of the present invention.

FIG. 3 is a partial cut away side view of a heat convection channel (HCC) lamp having a tube-shape in accordance with yet another embodiment of the present invention.

### DETAILED DESCRIPTION OF PREFERRED EMBODIMENTS

The following detailed description is of the best currently contemplated modes of carrying out the invention. The description is not to be taken in a limiting sense, but is made merely for the purpose of illustrating the general principles of the invention, since IS the scope of the invention is best defined by the appended claims.

Unless defined otherwise, all technical and scientific terms used herein have the same meaning as commonly understood by one of ordinary skill in the art to which this invention belongs. Although any materials similar or equivalent to those described herein can be used in the practice or testing of the present invention, the preferred materials are now described.

### First Embodiment

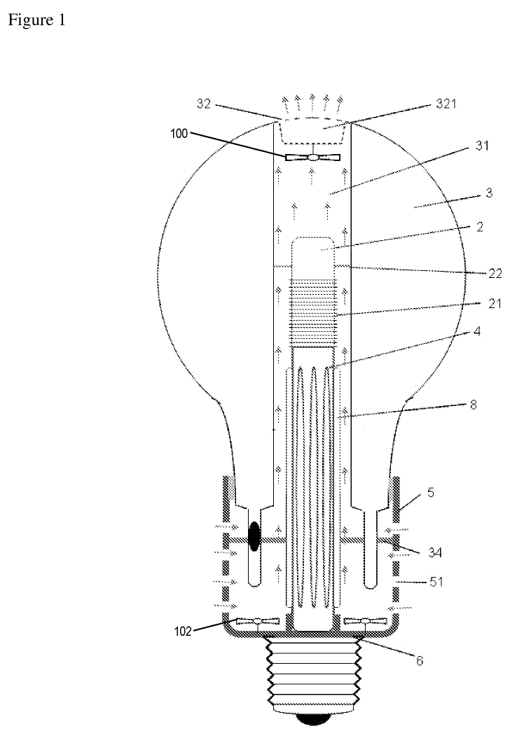

Referring now to FIG. 1, FIG. 1 is a partial cut away side view of a heat convection channel (HCC) lamp having a pear-shape in accordance with one embodiment of the present invention. As shown in FIG. 1, a lamp 3 is a pear-shaped glass bulb and the inside wall of the glass bulb is coated with a fluorescent phosphor mixture. The inside of the lamp is filled with an inert buffer gas.

At the center of the lamp 3 is a heat convection channel 31 and this channel extends through the length of the lamp 3. A power coupler 2 preferably formed of ferrite, seats in the middle of the heat convection channel 31. A meshed metal cover 32 is disposed at one end of the channel 31 to ensure free air flow there through.

An induction coil 21 is electrically connected to an external high frequency generator (not shown in FIG. 1) and a heat dissipating rod 4 is attached to the power coupler 2. The lamp 3 and the heat dissipating rod 4 are fixed to a lamp bulb and heat dissipating rod bracket 34 which is a part of the lamp cap 5. The lamp cap 5 has more than two heat convection holes 51 in its shell wall. The heat convection holes 51 can have any suitable dimension and shape, such as oval, rectangle, circle, polygon, or even artistic shape. The heat convection holes 51, the heat dissipating channel 31, and the meshed metal cover 32 together constitute an open channel for free air exchange.

The ambient air drawn into the lamp cap 5 through the holes 51 flows through the heat convection channel 31, extracting heat energy from the heat dissipating rod 4 and the power coupler 2, and exits the lamp through the meshed metal cover 32. The heat generated by the power coupler 2 is conducted to the heat dissipating rod 4. To maximize heat dissipation, heat dissipating fins 8 are arranged lengthwise on the heat dissipating rod 4.

For simple installation and maintenance, the lamp cap 5 has a standard lamp mount 6 on its bottom, and the standard lamp mount 6 and the lamp cap 5 are integrated into one structure. The standard lamp mount 6 may engage into a stand lamp socket (not shown in FIG. 1) coupled to an external high frequency generator so that the induction coil 21 is powered by the external high frequency generator.

To hold the power coupler 2 in position and to thereby prevent the power coupler 2 from touching the inside wall of the glass bulb of the lamp 3, a power coupler bracket 22 is clipped onto the power coupler 2. Likewise, the lamp bulb and heat dissipating rod bracket 34 holds the lamp 3 and the heat dissipation rod 4 in position relative to the lamp cap 5. Both the brackets 22 and 34 have a form of wire, instead of solid plate, to assure both free air flows and the stableness of the power coupler 2.

To make cleaning easy and convenient, the meshed metal cover 32 has a detachable structure. Underneath the meshed metal cover 32, a net cassette 321 can be disposed for placement of fragrance or bug repellant.

Optionally, electromagnetic fans 100, 102 can be installed in the heat convection channel 31 and the lamp cap 5. These fans 100, 102 are coated with electromagnetic materials so that they are driven by the impact of the electromagnetic field, boosting the air flows to further enhance convection. The electromagnetic fans 100, 102 do not need to be electrically powered. When the fans turn, they consume extra electromagnetic energy, which will incur two beneficial effects: 1) reducing heat in the process of field and motion energy conversion, and 2) reducing electromagnetic radiation.

The discharge of in the lamp is maintained by means of an alternating EM field incurred by the electrical current going through the induction coil 21 around the power coupler 2. The EM field excites the inert gas in the bulb 3 to emit UV light. The wall of the lamp is coated on the inside with fluorescent phosphor mixtures. These phosphor mixtures convert UV light into visible light.

### Second embodiment

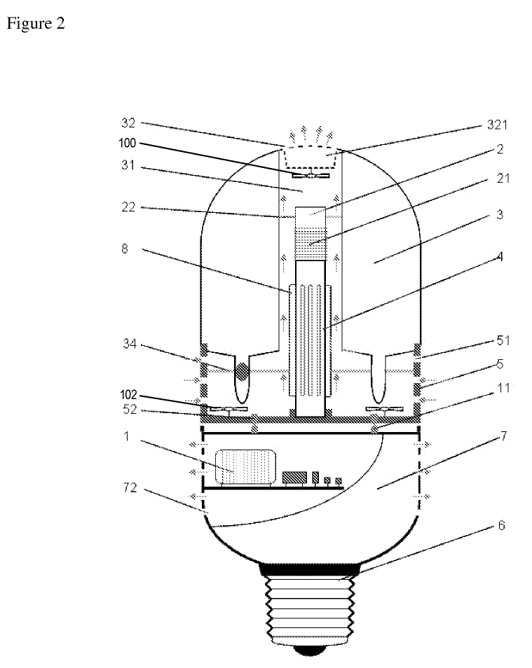

FIG. 2 is a partial cut away side view of a heat convection channel (HCC) lamp having a bullet-shape in accordance with another embodiment of the present invention. As depicted in FIG. 2, a high frequency generator 1 is disposed inside the generator shell 7 and connected to the lamp mount 6. The generator shell 7 is detachably screw-mounted onto the lamp cap 5. As in the case of the first embodiment, the lamp 3 has a heat convection channel 31 inside itself and the channel extends throughout the lamp 3. The power coupler 2 is disposed in the middle of the heat convection channel 31 within the lamp 3. The heat dissipating rod 4 is attached to the power coupler 2 while the lamp 3 and the heat dissipating rod 4 are fixed onto the lamp cap 5 by use of a bracket 34.

The high frequency generator 1 seats inside the generator shell 7. The bottom of the generator shell 7 has a standard lamp mount 6, and the generator shell 7 and the standard lamp mount 6 forms an integral body. The top of the generator shell 7 has power source electrodes 11.

The bottom of the lamp cap 5 has light source electrodes 52 connected to the induction coil 21. The generator shell 7 is connected to the lamp cap 5 via a screw mechanism in such a way that the power source electrodes 11 are in firm contact with the light source electrodes 52. The lamp cap 5 has more than two holes in the shell and the holes can be of oval, rectangular, round, polygonal and abnormal shapes.

The generator shell 7 is made of heat-radiating material and has multiple heat dissipating holes 72. These holes in the high frequency generator shell 7 can be of the same or different shape as the holes in the shell wall of the lamp cap 5. The high frequency generator 1 can have double-sided circuit board. It may also have high heat-radiating coatings on key electronic components and micro groove heat dissipating fins.

In the present embodiment, the high frequency generator 1 and the lamp 3 are integrated together, though the two parts are detachable. This integrated but detachable structure makes installation very easy and convenient, just like a conventional incandescent or fluorescent lamp. It also makes it possible to replace only the broken part, saving cost of maintenance and restoration. For users who need different color temperatures at different times, they can just purchase the different lamps while using the same generator shell 7.

As in the case of the first embodiment, the heat-radiating fins 8, power coupler bracket 22, electromagnetic fans 100, 102, meshed metal cover 32, and cassette 321 may also be installed in the lamp system. For brevity, detailed description of these components is not repeated.

### Third Embodiment

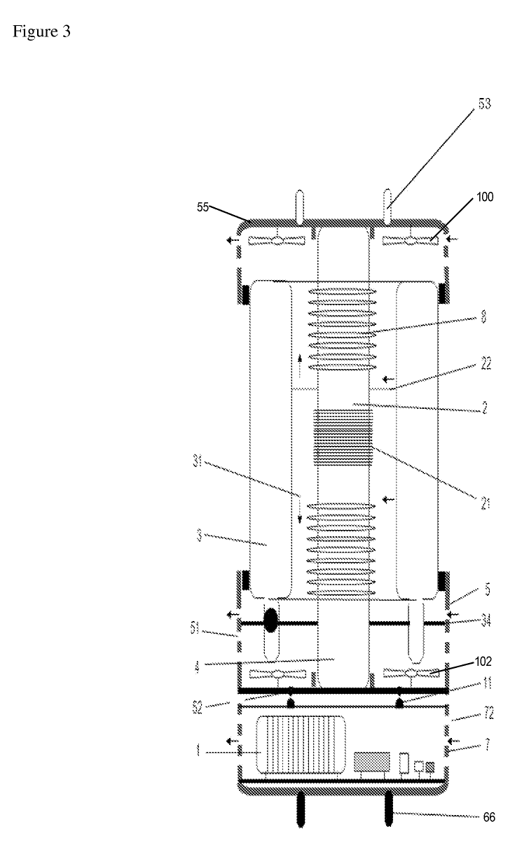

FIG. 3 is a partial cut away side view of a heat convection channel (HCC) lamp having a tube-shape in accordance with yet another embodiment of the present invention. As shown in FIG. 3, the lamp 3 has a tube-shape, the heat convection channel 31 extends through the length of the lamp 3, and the lamp 3 has the lamp caps 5, 55 on both of its ends. The glass tube of the lamp 3 and the lamp caps 5, 55 are glued together. Each lamp cap has more than two holes 51. The high frequency generator 1 seats inside the generator shell 7 and the generator shell 7 has a standard lamp mount 66. The generator shell 7 and the standard lamp mount 66 forms an integral body.

The generator 7 has power source electrodes 11 on its top. The high frequency generator 1 is connected to the standard lamp mount 66. The lower lamp cap 5 has light source electrodes 52 connected to the induction coil 21. The top lamp cap 55 has mounting racks 53. The standard lamp mount 66 and the mounting racks 53 are of the same specification of a conventional fluorescent lamp, assuring the convenience in installation and use.

The generator shell 7 is screw-mounted onto the lower lamp cap 5. The power source electrodes 11 and the light source electrodes 52 are in firm contact with each other when the generator shell 7 and the lamp cap 5 are combined by a screw mechanism. The generator shell 7 has more than two holes 72 in the shell wall for heat convection.

Two heat dissipating rods 4 are respectively attached to ends of the power coupler 2. Each heat dissipating rod 4 has axial heat dissipating fins 8. These two heat dissipating rods 4 protrude out of the both ends of the lamp 3. To further stabilize the power coupler 2 and the heat dissipating rods 4, wired bracket 34 is used.

When this tube-shaped integrated HCC discharge lamp is on, the heat energy generated by the power coupler 2 is conducted to the heat dissipating rods 4. The heat dissipating rods 4 heat up the air in the heat convection channel 31. The heated air moves upwards and turns to the sides when it hits the upper lamp cap 55. As heat dissipating holes 51 are formed in the upper lamp cap 55, the hotter air moves out of the lamp through the upper holes and cooler air is drawn in through the lower holes in the lower lamp cap 5, forming a free air convection that keeps the lamp cool.

The high frequency generator 1 can be installed inside or outside the lamp, and in cases, standard lamp mounts 66 and mounting racks 53 are used.

As discussed above, the HCC discharge lamp of the present invention uses the heat convection principle to dissipate heat energy generated by the power coupler. This will make the commercialization of the discharge lamp much easier.

The HCC discharge lamp of the present invention can have a detachable high frequency generator and uses a standard lamp mount on the lamp cap. The induction coil is connected, through the standard lamp mount, to the detached high frequency generator and power electrodes.

The HCC discharge lamp of the present invention can also have an integrated high frequency generator, i.e., the high frequency generator is installed inside the structure of the lamp system. The cap of the generator includes a standard lamp mount and is attached to the lamp cap to make an integrated lamp. The generator is electrically connected to the standard lamp mount. The lamp cap has power source electrodes that are connect to the induction coil. Both generator and lamp caps have more than 2 holes for heat convection.

The HCC discharge lamp of the present invention has more than 2 heat dissipating fins seating vertically on the heat dissipating rod.

The HCC discharge lamp of the present invention may have a detachable coated meshed metal cover and a net cassette can be disposed underneath the meshed metal cover.

The HCC discharge lamp of the present invention may have a tube-shaped lamp and the HCC extends throughout the tube; the tube has fixed lamp caps on both of its ends and both lamp caps have more than two heat convection holes; and heat dissipating rods are attached to the power coupler on both ends.

For a tube-shaped HCC discharge lamp, the high frequency generator can also be installed inside or outside the lamp and in both cases standard lamp mount and mounting racks are used.

The HCC lamp of the present invention has the following technical effects:
1. The HCC discharge lamp improves the way heat is dissipated via a heat convection system that includes: an open channel extending throughout the body of the lamp; a meshed metal cover on the tip of the lamp bulb, which is also located at one end of the heat convection channel; holes in the lamp cap which is on the opposite end of the heat convection channel, and heat dissipating fins on the heat dissipating rod. This system enables the heat generated by the power coupler to be dissipated efficiently by the air flow through the HCC.
2. The HCC discharge lamp has a detachable meshed metal cover at the tip of the lamp bulb which is located at an end of the heat convection channel. The meshed metal cover, which has an insulating coating, not only prevents insects and foreign materials from entering into the lamp but also shields the electromagnetic field in the lamp so as to make the lamp safer and healthier.
3. The HCC discharge lamp replaces the traditional heat dissipating system with a new system that eradicates the problem of having to use nonstandard mounting systems due to the large heat dissipating plate. The new system will lend itself to various standard lamp mounts and will be much more convenient for installation and maintenance.
4. The HCC discharge lamp can have both detachable and integrated high frequency generators. The integrated system has the generator built inseparably in the lamp. The detachable system is designed such that the generator can be screw-mounted on and off the lamp, making it possible, therefore, to replace only the lamp or the generator or to replace lamps of different colors, shapes, or color temperatures.
5. The HCC discharge lamp can use lamp bulbs of different shapes, such as pear, bullet, polygon, and tube. This will considerably broaden the use of this lamp.
6. The HCC discharge lamp has a detachable coated meshed metal cover and a net cassette fixed underneath it. Because it is detachable, it can be taken off of the lamp very easily for cleaning or for placing fragrance or bug repellant in the cassette.
7. The HCC discharge lamp considerably increases the heat dissipation and is very easy to install and use. It also reduces the manufacturing cost and has a broad range of applications, such as for industries, tunnels, office buildings, public areas and facilities, outdoor environment, and homes.
8. The HCC discharge lamp has an operating frequency ranging from 250 KHz through 2.65 MHz.

While the present invention has been described with reference to the specific embodiments thereof, it should be understood, of course, that the foregoing relates to preferred embodiments of the invention and that modifications may be made without departing from the spirit and scope of the invention as set forth in the following claims.

What is claimed is:

1. An electromagnetic discharge lamp system, comprising:
a lamp operative to generate light by use of an electromagnetic field and having a channel extending there through, said channel being configured to communicate with ambient air and allow the ambient air to flow there through,
whereby the ambient air flowing through the channel extracts heat energy from the lamp system during operation.

2. An electromagnetic discharge lamp system as recited in claim 1, further comprising:
an induction coil connected to a generator for generating a high frequency current; and
a power coupler operatively coupled to the induction coil and configured to generate the electromagnetic field.

3. An electromagnetic discharge lamp system as recited in claim 2, further comprising:
at least one heat dissipating rod disposed in the channel and attached to the power coupler to dissipate heat energy generated by the power coupler.

4. An electromagnetic discharge lamp system as recited in claim 3, further comprising:
a plurality of fins attached to the heat dissipating rod.

5. An electromagnetic discharge lamp system as recited in claim 4, wherein the fins are arranged along an axial direction of the heat dissipating rod or a direction normal to the axial direction.

6. An electromagnetic discharge lamp system as recited in claim 3, further comprising:
at least one lamp cap secured to the lamp and the heat dissipating rod and having holes through which the ambient air passes through; and
a lamp mounts.

7. An electromagnetic discharge lamp system as recited in claim 2, wherein the generator is disposed external to the lamp system and wherein the lamp cap and the lamp amount form an integral body.

8. An electromagnetic discharge lamp system as recited in claim 6, further comprising:
a generator cap housing the generator and screw-mounted to the lamp cap.

9. An electromagnetic discharge lamp system as recited in claim 8, wherein the generator cap has holes for heat convection.

10. An electromagnetic discharge lamp system as recited in claim 8, wherein the generator cap and the lamp mount form an integral body.

11. An electromagnetic discharge lamp system as recited in claim 8, wherein the lamp cap includes light source electrodes and the generator cap includes power source electrodes and wherein the light source electrodes are in firm contact with the power source electrodes when the lamp cap is detachably secured to the generator cap.

12. An electromagnetic discharge lamp system as recited in claim 6, further comprising:
a lamp bulb and heat dissipating rod bracket for holding the lamp and the heat dissipating rod in place relative to the lamp cap.

13. An electromagnetic discharge lamp system as recited in claim 6, further comprising:
a power coupler bracket for holding the power coupler in place relative to the lamp.

14. An electromagnetic discharge lamp system as recited in claim 6, wherein two lamp caps are disposed on both sides of the lamp and one of the two lamp caps includes a mounting rack.

15. An electromagnetic discharge lamp system as recited in claim 1, further comprising:
a meshed metal cover disposed at one end of the channel.

16. An electromagnetic discharge lamp system as recited in claim 15, further comprising:
a net cassette disposed beneath the meshed metal cover in the channel.

17. An electromagnetic discharge lamp system as recited in claim 1, further comprising:
one or more electromagnetic fans for boosting an air flow through the channel.

18. An electromagnetic discharge lamp system as recited in claim 17, wherein the fans are coated with electromagnetic material and driven by the electromagnetic field.

19. An electromagnetic discharge lamp system as recited in claim 1, wherein the lamp is filled with an inert gas and includes a coating applied to an inside wall thereof and wherein the coating converts a UV light into a visible light.

20. An electromagnetic discharge lamp system as recited in claim 2, wherein the high frequency current has a frequency range of 250 KHZ-2.65 MHz.
